(19) United States
(12) Patent Application Publication
(10) Pub. No.: US 2020/0214937 A1
(43) Pub. Date: Jul. 9, 2020

(54) MIXING DEVICE

(71) Applicant: HUBERTUS GOLLER GESELLSCHAFT M.B.H., Klosterneuburg (AT)

(72) Inventor: Friedrich PIPELKA, Klosterneuburg (AT)

(21) Appl. No.: 16/629,876

(22) PCT Filed: Jan. 26, 2018
(86) PCT No.: PCT/AT2018/060026

§ 371 Date: Jan. 9, 2020

(30) Foreign Application Priority Data
Feb. 8, 2017 (AT) A 50102/2017

(51) Int. Cl. A61J 1/20

(52) U.S. Cl. CPC A61J 1/2062; A61J 1/2096; A61J 1/2037; A61J 1/201

(57) ABSTRACT

A mixing device for supplying media from containers, mixing media in containers and dispensing media or mixtures of the media into containers, including a connecting element and a shut-off unit. The connecting element has multiple container connections and a guide bore with a connecting duct extending from each container connection to the guide bore, leading to a wall of the guide bore. The shut-off unit is mounted in the guide bore of the connecting element so as to be rotatable about its longitudinal axis and displaceable along its longitudinal axis. In the shut-off unit, a distribution duct is formed, which can be brought into alignment with different connecting ducts, depending on a position of the shut-off unit, wherein different connecting ducts can be brought into mutual media communication by rotating and/or axially displacing the shut-off unit in a switchable manner.

The invention relates to a mixing device for supplying media from containers, mixing media in containers and dispensing media or mixtures of the media into containers, comprising a connecting element and a shut-off unit, with the connecting element having a plurality of container connections and a guide bore and with at least one connecting duct extending from each container connection to the guide bore, leading to a wall of the guide bore, wherein the shut-off unit is mounted in the guide bore of the connecting element so as to be rotatable about its longitudinal axis and displaceable along its longitudinal axis.

Transfer devices for transferring and mixing media are known by means of which a first medium can be transferred from a first container plugged onto the transfer device into a second container plugged onto the transfer device. Such transfer devices are frequently used in the medical field for the mixing of two substances, without the substances being contaminated or even leaking during the mixing or, respectively, transfer. In this context and due to the ease of handling, vial containers characterized by a glass container, which is closed by a pierceable plug, have become established as containers. When such a vial container is plugged onto the transfer device, the plug is pierced by a hollow needle formed on the transfer device, with the hollow needle and the plug sealingly abutting each other. For regulating the transfer process or, respectively, the mixing process, a shut-off unit can be formed on the transfer device, by means of which handling and safety are increased for the user operating the transfer device.

Such a transfer device for transferring or, respectively, mixing media is known, for example, From patent AT 514 328 B 1.

The transfer device known from patent AT 514 328 B1 has turned out to be disadvantageous in that, for the purpose of supplying the mixed or, respectively, transferred substance to further use, the vial container must be unplugged from the transfer device, whereby leaking of the mixed or, respectively, transferred substance and/or a contamination of the substance may occur through the hole pierced into the plug by the hollow needle. Often, a minor carelessness on the part of the user or a jerky movement during the unplugging of the vial container is already enough for this.

Furthermore, the transfer device has turned out to be disadvantageous in that one of the vial containers must be charged with a negative pressure in order to support the material transport within the transfer device. So as to ensure safe handling of the vial container and to avoid contamination of an interior of the vial container, the vial container must be charged with a vacuum in an absolutely sterile environment, whereby this is generally performed by the manufacturer after or before the vial container is filled. In this case, the negative pressure in one of the two vial containers must be at least so large that a relative pressure between the vial containers will adjust itself which is sufficient for creating a medium flow between the vial containers through the transfer device against a frictional resistance or, respectively, a capillary action of a transfer duct of the transfer device. However, the generation of the negative pressure constitutes a not insignificant expense during the filling of the vial containers and is therefore expensive and complex. Furthermore, when the transfer device is used, it must be made sure that the relative pressure between the two plugged-on vial containers is sufficient for conveying a medium through the transfer device.

It is therefore the object of the present invention to build a mixing device which develops further the initially mentioned transfer device and involves the possibility of mixing several media with each other and of supplying the mixed medium to further use, without any risk of leaking or, respectively, contaminated media.

According to the present invention, the present object is achieved in that, in the shut-off unit, at least one distribution duct having orifices in a peripheral wall of the shut-off unit is formed, wherein orifices of the distribution duct can be brought into sealing alignment with orifices of the connecting ducts, depending on a position of the shut-off unit, and those connecting ducts can thereby be brought into mutual media communication and different connecting ducts can be brought into mutual media communication by rotating and/or axially displacing the shut-off unit in a switchable manner.

Due to the design according to the invention of the mixing device, the advantage is obtained that different containers can be brought into mutual media communication relative to the connecting element, depending on the position of the shut-off unit. As a result, the media stored in the various containers can be mixed safely and without contamination from the outside.

Preferably, the containers are formed by syringes and vial containers. In this way, the advantage is obtained that the syringes can be used for transporting the media, in particular fluids, through the mixing device. As a result, the use of vial containers charged with a vacuum can be omitted. A syringe is preferably configured as an injection syringe into which the mixture produced in the mixing device is filled. As a result, the advantage is obtained that the mixture can be supplied to further use without contamination from the outside and without leakage from the injection syringe, without being transferred a further time. Furthermore, syringes provide the advantage that a very good mixing of the fluids can be achieved as a result of turbulences arising when the syringe is drawn up or squeezed out. Moreover, the syringes provide the advantage that a mixing ratio of the media can be adjusted via a draw-up volume or, respectively, a squeezing volume of the syringes, whereby metering of the media during mixing is no longer restricted to just one volume.

Furthermore, the advantage is obtained by the mixing device according to the invention that several media are miscible with each other in different sequences. Advantageously, a mixing sequence of different media is determined by the design of the connecting element and the shut-off unit and/or by a specification of rotation and displacement possibilities of the shut-off unit. Suitably, each container comprising its included medium is associated to a container connection and can be plugged only into said connection. Furthermore, various stoppers or detent recesses are advantageously attached to the connecting element or the shut-off unit in order to bring the corresponding containers into mutual media communication through the shut-off unit only in a predetermined sequence. As a result, an error in the mixing sequence can be ruled out, which contributes mainly to safe handling of the media and whereby unnecessary disposals of wrongly mixed media can be avoided.

Advantageously, at least one container connection is designed as a Luer lock connector. As a result, the advantage is obtained that containers, in particular containers in the form of syringes, can be coupled to the mixing device and decoupled from the mixing device with one movement of the hand. Consequently, safe handling of the mixing device is ensured also with gloves. Furthermore, the Luer lock connector provides the advantage that, due to its frequent use in a medical environment, a variety of medical devices can be connected to the mixing device, such as, for example, different types of cannulas, tubes, etc.

At least one container connection is advantageously designed as a vial connection. As a result, the advantage is obtained that vial containers can be coupled to the mixing device and decoupled from the mixing device with one movement of the hand. In this case, the vial connection is advantageously formed by a protrusion projecting from an external surface of the connecting element, which protrusion pierces a plug of the vial container as a result of a vial container being plugged onto the mixing device, whereby a medium communication is established between the interior of the vial container and the connecting duct. Suitably, the protrusion is designed as a hollow needle and forms the extension of the connecting duct. The hollow needle is advantageously made of a synthetic material or stainless steel.

Preferably, the connecting element and/or the shut-off unit is/are made of a synthetic material and manufactured by means of injection moulding.

Suitably, the connecting element comprises latching lugs, the latching lugs being designed for supporting the containers. As a result, the advantage is obtained that containers, in particular vial containers, are supported by the mixing device after they have been attached to the mixing device. Advantageously, the latching lugs are designed such that the vial containers can be released from the mixing device in a non-destructive way by applying a gentle force with one movement of the hand.

Advantageously, the shut-off unit comprises a plurality of distribution ducts located in different axial planes of the shut-off unit. The distribution ducts can run through the shut-off unit in a straight line, in an angled fashion and/or they can run through the shut-off unit with a bend. As a result, the advantage is obtained that different connecting ducts can be brought into media communication not only by twisting the shut-off unit, but they can be brought into media communication also via the axial displacement of the shut-off unit.

In a further embodiment variant, the mixing device comprises at least one connection coupling which can be connected to the connecting element via the at least one Luer lock connector and which comprises a vial connection. When a connection coupling is plugged onto the connecting element, a coupling duct formed in the connection coupling is connected, for communication, to the connecting duct extending from the at least one Luer lock connector to the guide bore. As a result, the connection coupling constitutes a link between the vial connection and the Luer lock connector. In this way, the advantage is obtained that the connecting element can always be designed in the same way, for example, only with Luer lock connectors as container connections, and, if vial connections are required, the connection couplings can be coupled to the connecting element.

In a further embodiment variant, the distributing ducts have branches which lead to the external wall of the shut-off unit. As a result, the advantage is obtained that several containers can be brought into mutual media communication simultaneously.

In a further embodiment variant, the orifices of the distributor duct are formed in different axial planes of the shut-off unit.

In this context, a medium is considered to consist in substances in a gaseous, liquid or solid physical state. The term medium covers in particular liquids, gases or powders.

Further advantageous embodiments of the mixing device according to the invention will be explained in further detail below with reference to the figures.

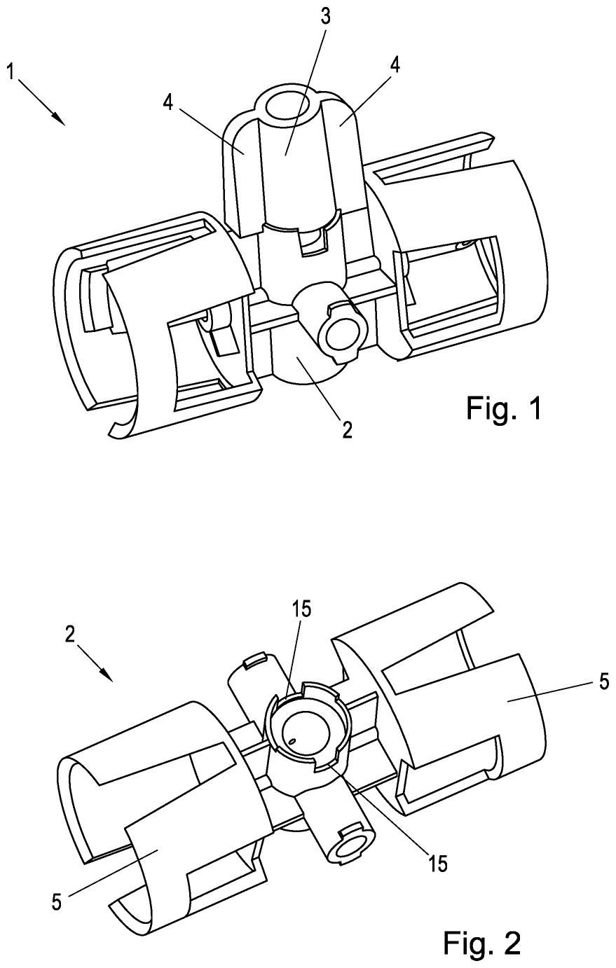

FIG. 1 shows a first embodiment variant of the mixing device according to the invention in a perspective view.

FIG. 2 shows a connecting element of the embodiment variant of the mixing device according to FIG. 1 in a perspective view.

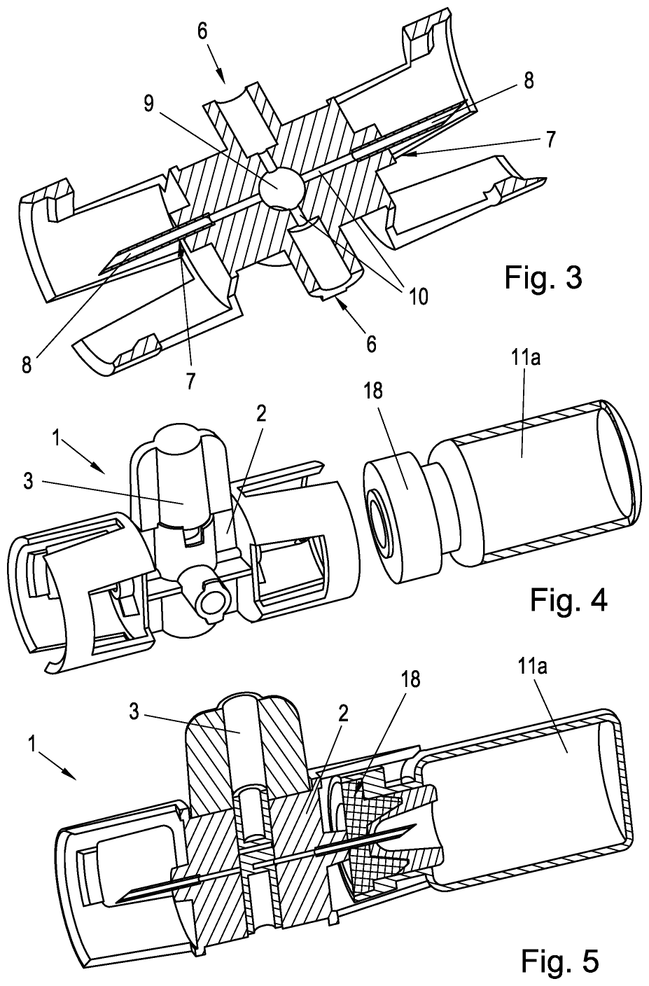

FIG. 3 shows the connecting element as shown in FIG. 2 in a perspective sectional view.

FIG. 4 shows the embodiment variant of the mixing device according to FIG. 1 in a perspective view during the plugging of a vial container onto the connecting element.

FIG. 5 shows the embodiment variant of the mixing device according to FIG. 1 in a perspective sectional view with a plugged-on vial container.

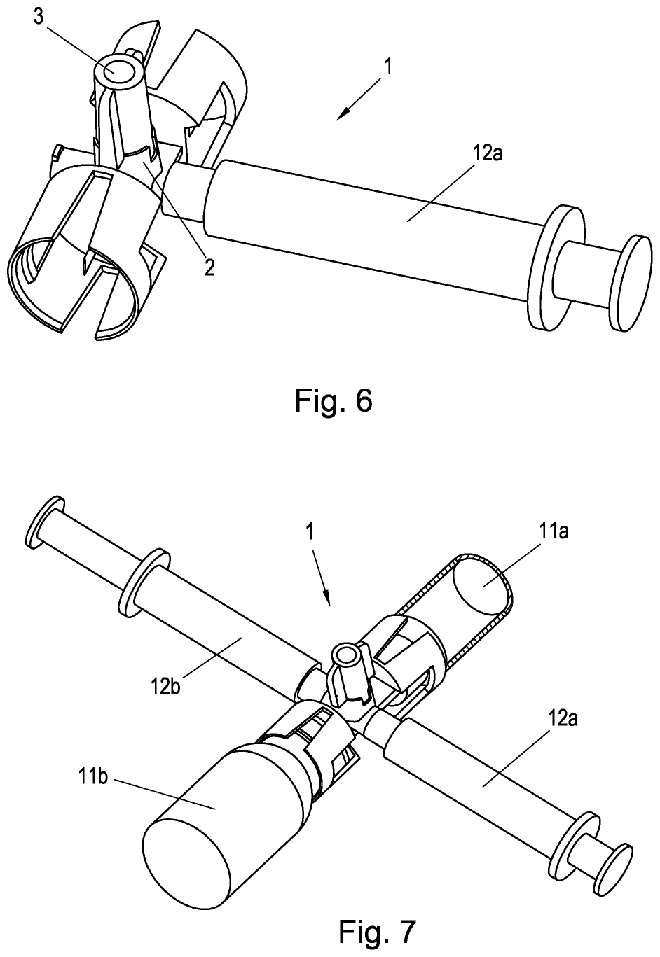

FIG. 6 shows the embodiment variant of the mixing device according to FIG. 1 in a perspective view with a plugged-on syringe.

FIG. 7 shows the embodiment variant of the mixing device according to FIG. 1 in a perspective view with two syringes plugged onto the connecting element and two plugged-on vial containers.

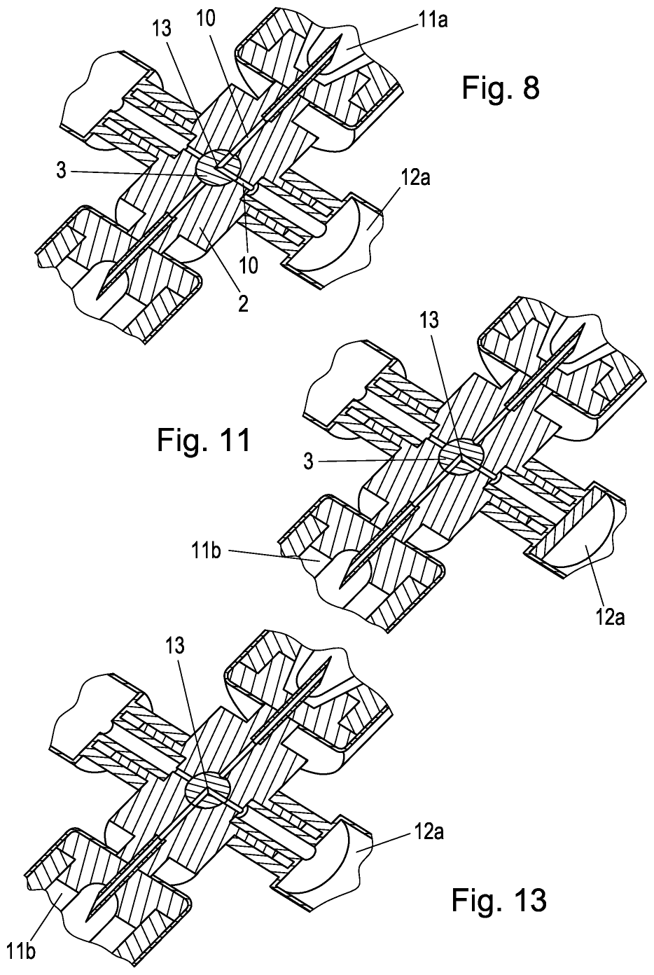

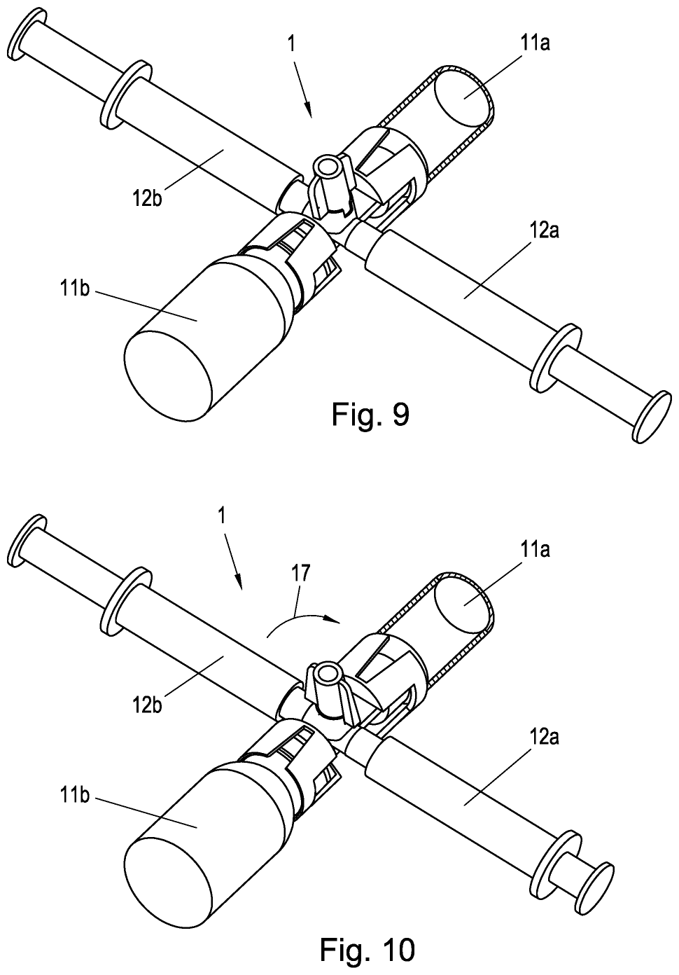

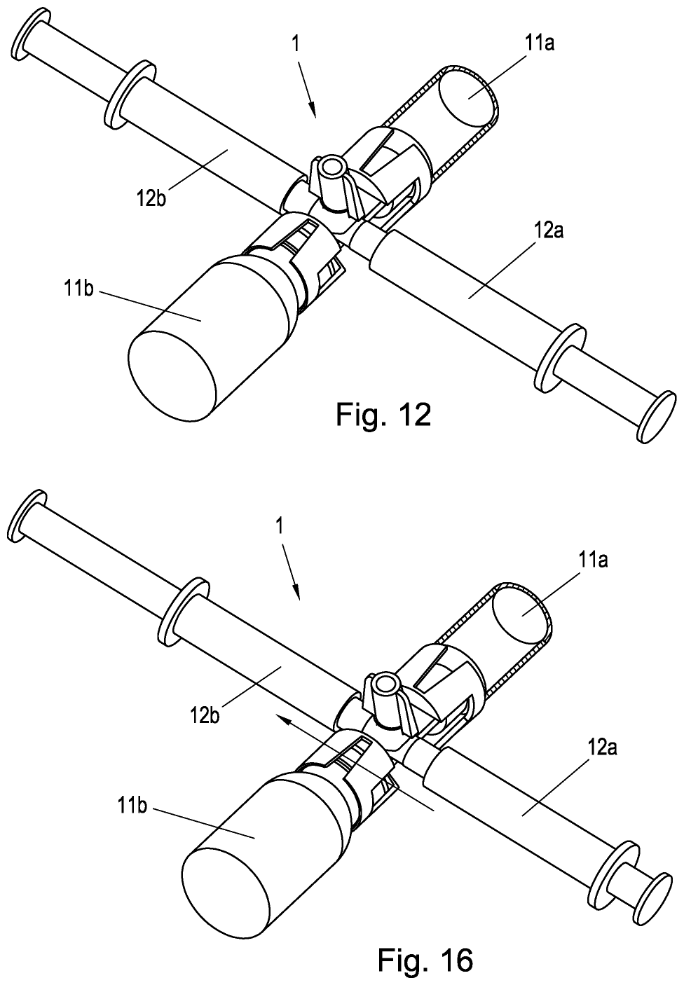

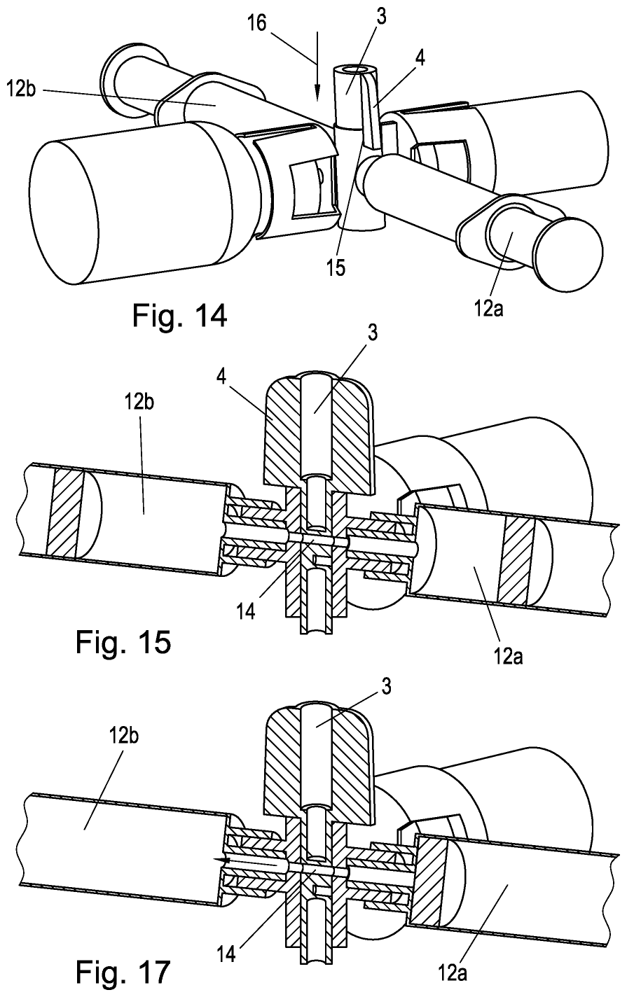

FIGS. 8 to 17 each show the embodiment variant of the mixing device according to FIG. 1 in a perspective (sectional) view during the mixing process.

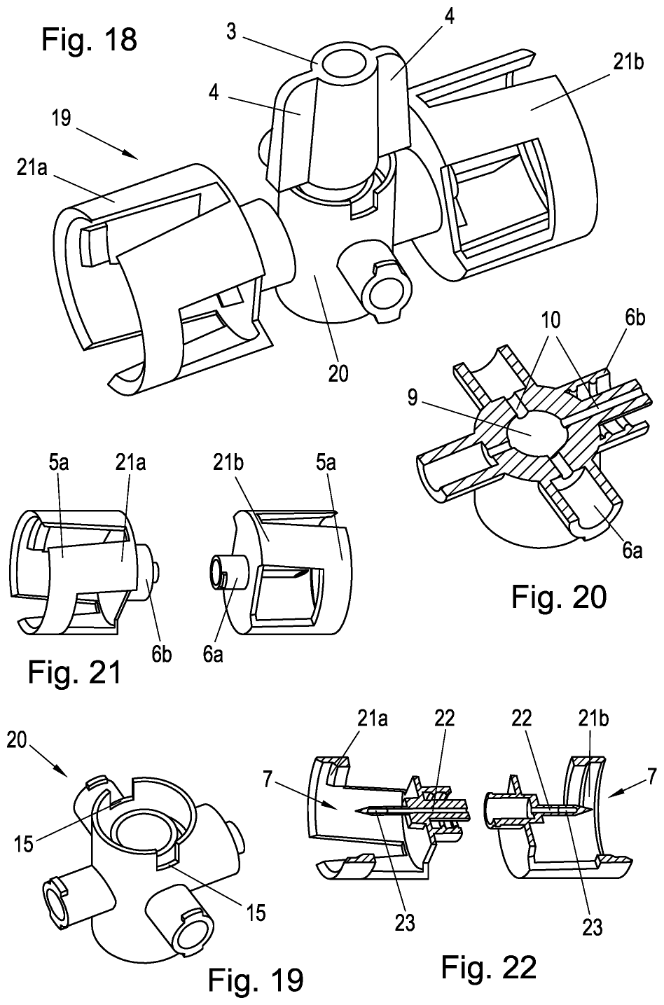

FIG. 18 shows a further embodiment variant of the mixing device in a perspective view with two plugged-on connection couplings.

FIGS. 19 and 20 each show a connecting element of the embodiment variant of the mixing device according to FIG. 18 in a perspective (sectional) view.

FIGS. 21 and 22 each show two connection couplings of the embodiment variant of the mixing device according to FIG. 18 in a perspective (sectional) view.

FIG. 1 shows, in a perspective view, an embodiment variant of a mixing device 1 according to the invention for feeding media from containers, mixing media in containers and dispensing media or mixtures of the media into containers. The mixing device 1 according to the invention comprises a connecting element 2 and a shut-off unit 3, wherein the shut-off unit 3 is mounted in a guide bore 9 of the connecting element 2 so as to be rotatable about its longitudinal axis and displaceable along its longitudinal axis. At the shut-off unit 3, two wings 4 are formed in an upper region.

FIG. 2 shows the connecting element 2 in a perspective view. Latching lugs 5 and latching grooves 15 are formed on the connecting element 2.

FIG. 3 shows the connecting element 2 in a perspective sectional view. The connecting element 2 comprises four container connections which are formed by two Luer lock connectors 6 and two vial connections 7. The vial connections 7 each have a protrusion formed by a hollow needle 8. A connecting duct 10 extends, in each case, from a wall of the guide bore 9 to one vial connection 7 each, and a connecting duct 10 extends, in each case, to one Luer lock connector 6 each. In this embodiment variant, the Luer lock connectors 6 are configured as female Luer lock connectors, but they may also be formed by male Luer lock connectors. The connecting ducts 10, which extend to the vial connections 7, are arranged coaxially to the hollow needle 8 and form the extension of an interior of the hollow needle 8. The hollow needle 8 is advantageously made of stainless steel or a synthetic material and is glued into the connecting element 2. Preferably, the connecting element 2 is made of a synthetic material and manufactured by means of injection moulding. In the embodiment variant of the connecting element 2 as shown in FIG. 3, the connecting ducts 10 are all arranged in one plane.

FIG. 4 shows the mixing device 1 in a perspective view during the attachment of a first container which encloses a first medium in the form of a first liquid. The first container is formed by a vial container, which will be referred to hereinbelow as an outlet container 11a. When the outlet container 11a is plugged onto the connecting element 2, a plug 18 of the outlet container 11a is pierced by the hollow needle 8, whereby a media communication is established between the connecting duct 10 associated to the vial connection 7 and the outlet container 11a.

FIG. 5 shows the mixing device 1 in a perspective sectional view with the connection container 11a plugged on. When the connection container 11a is plugged onto the connecting element 2, the connection container 11a is held by the latching lugs 5, with the latching lugs 5 being designed such that it is possible to release the connection container 11a from the connecting element 2 by applying a minor force.

FIG. 6 shows the mixing device 1 in a perspective view with a second container plugged onto the connecting element 2 via the Luer lock connector 6. The second container is formed by a syringe, which is referred to hereinbelow as a mixing syringe 12a.

FIG. 7 shows the mixing device 1 in a perspective view with a connection container 11a plugged onto the connecting element 2 and a plugged-on mixing syringe 12a. Furthermore, a third and a fourth container are plugged onto the mixing device 1. The third container is formed by a further vial container which encloses a second medium in the form of a second liquid and which is referred to hereinbelow as a mixing container 11b. The fourth container is formed by a further syringe, which is referred to hereinbelow as an injection syringe 12b. The individual containers are plugged onto the connecting element 2 in such a way that an interior of the plugged-on containers will communicate with the respective connecting duct 10 associated to the container connection.

FIGS. 8 to 17 show the mixing device 1 during the mixing of two media and during the filling of the mixture into the injection syringe 12b. In a first position, the shut-off unit 3 is positioned relative to the connecting element 2 such that a first distribution duct 13 formed in the shut-off unit 3 connects an interior of the first outlet container 11a, for communication, to an interior of the mixing syringe 12a via the respective connecting ducts 10. By drawing up the mixing syringe 12a, a negative pressure is generated inside the mixing syringe 12a, whereby the first liquid is conveyed from the outlet container 11a into the mixing syringe 12a. Depending on a draw-up volume of the mixing syringe 12a, a quantity required for the mixture can be adjusted. Through a 90 degree rotation of the shut-off unit 3 in the direction of rotation 17, the shut-off unit 3 is shifted into a second position. In the second position, the interior of the mixing syringe 12a is connected, for communication, to an interior of the mixing container 11b via the first distribution duct 13 and the corresponding connecting ducts 10. By squeezing the first liquid from the first mixing syringe 12a, the first liquid is conveyed into the mixing container 11b, whereby the first liquid mixes with the second liquid. In the further step, the mixture is conveyed back into the interior of the first mixing syringe 12a by drawing up the mixing syringe 12a. Due to the turbulences arising when the mixing syringe 12a is being drawn up, the advantage is obtained that a high degree of mixing of the liquids is achieved.

Due to the rotation of the shut-off unit 3 into the second position, the wings 4 of the shut-off unit 3 are positioned relative to the latching grooves 15 in such a way that the shut-off unit is displaceable into a third position by a compressive axial force 16. Due to the axial displacement of the shut-off unit 3 relative to the connecting element 2, further twisting of the shut-off unit 3 is inhibited by the latching grooves 15 and a second distribution duct 14 is transported into the plane in which the connecting ducts 10 are located. Due to the rectilinear shape of the second distribution duct 14, in the third position, the interior of the mixing syringe 12a is connected, for communication, to an interior of the injection syringe 12b via the connecting element 2. By simultaneously squeezing out the mixing syringe 12a and drawing up the injection syringe 12b, the mixed liquid is conveyed into the injection syringe 12b. Thus, the mixing process is completed, and the injection syringe 12b can be unplugged from the mixing device 1, and the mixed liquid can be supplied to further use.

In a further embodiment variant, the second medium is formed by a powder.

In a further embodiment variant, three media are mixed together in the mixing device 1, with the mixing syringe 12a already containing a third medium in the form of a third liquid prior to the mixing process.

In a further embodiment variant, four media are mixed together in the mixing device 1, with the mixing syringe 12a already containing a third medium in the form of a third liquid prior to the mixing process and the injection syringe 12b already containing a fourth medium in the form of a fourth liquid prior to the mixing process.

FIG. 18 shows, in a perspective view, a further embodiment variant of the mixing device 19 for supplying media from containers, mixing media in containers and dispensing media or mixtures of the media into containers. In contrast to the mixing device 1 according to FIG. 1, the mixing device 19 comprises a connecting element 20, in which the container connections are formed only by Luer lock connectors 6. For the plugging of vial containers onto the mixing device 18, a first connection coupling 21a and a second connection coupling 21b are formed, each of them connectable to the Luer lock connectors 6.

FIG. 19 shows a detailed perspective view of the connecting element 20.

FIG. 20 shows a detailed perspective sectional view of the connecting element 20. Connecting ducts 10 connect the Luer lock connectors 6 to the guide bore 9. In this embodiment variant, the Luer lock connectors 6 are formed by three female Luer lock connectors 6a and by one male Luer lock connector 6b.

FIG. 21 shows the first connection coupling 21a and the second connection coupling 21b in a perspective view. The first connection coupling 21a comprises a male Luer lock connector 6b and a vial connection 7. The second connection coupling 21b comprises a female Luer lock connector 6a and a vial connection 7. In addition, further latching lugs 5a are formed both on the first connection coupling 21a and on the second connection coupling 21b, and both the vial connection 7 of the first connection coupling 21a and the vial connection 7 of the second connection coupling 21b have a protrusion in the form of a hollow needle 23 which projects from a surface of the connection coupling 21a, 21b. The hollow needle 23 forms the extension of the coupling duct 22 and is arranged coaxially thereto.

FIG. 22 shows the first connection coupling 21a and the second connection coupling 21b in a perspective sectional view. When the connection couplings 21a, 21b are plugged onto the connecting element 20, a coupling duct 22 formed, in each case, in the connection couplings 21a, 21b is oriented coaxially to the respective connecting duct 10 connecting the female Luer lock connector 6a or, respectively, the male Luer lock connector 6b to the guide bore 9 and is connected thereto for communication.

1.-15. (canceled)

16. A mixing device for supplying media from containers, mixing media in containers and dispensing media or mixtures of the media into containers, comprising a connecting element and a shut-off unit, with the connecting element having a plurality of container connections and a guide bore and with at least one connecting duct extending from each container connection to the guide bore, leading to a wall of the guide bore, wherein the shut-off unit is mounted in the guide bore of the connecting element so as to be rotatable about its longitudinal axis and displaceable along its longitudinal axis, wherein, in the shut-off unit, at least one distribution duct having orifices in a peripheral wall of the shut-off unit is formed, wherein orifices of the distribution duct can be brought into sealing alignment with orifices of the connecting ducts, depending on a position of the shut-off unit, and those connecting ducts can thereby be brought into mutual media communication and different connecting ducts can be brought into mutual media communication by rotating and/or axially displacing the shut-off unit in a switchable manner, and wherein the orifices of the at least one distributor duct are located in the same axial plane of the shut-off unit.

17. A mixing device according to claim 1, wherein the at least one distributor duct runs through the shut-off unit in a straight line.

18. A mixing device according to claim 1, wherein the at least one distributor duct runs through the shut-off unit in an angled fashion or with a bend.

19. A mixing device according to claim 16, wherein the at least one distributor duct has at least one branch which leads to the external wall of the shut-off unit.

20. A mixing device according to claim 16, wherein the shut-off unit comprises a plurality of distribution ducts located in different axial planes of the shut-off unit.

21. A mixing device according claim 16, wherein the connecting element comprises latching lugs, the latching lugs configured to support the containers.

22. A mixing device according to claim 16, wherein at least one container connection comprises a Luer lock connector.

23. A mixing device according to claim 22, wherein the mixing device comprises at least one connection coupling which can be connected to the connecting element via the Luer lock connector and which comprises a vial connection, wherein, when at least one connection coupling is connected to the connecting element, a coupling duct formed in the least one connection coupling is connected, for communication, to the connecting duct extending from the Luer lock connector to the guide bore.

24. A mixing device according to claim 23, wherein the vial connection comprises a protrusion projecting from an external surface of the connection coupling.

25. A mixing device according to claim 23, wherein the connection coupling comprises further latching lugs, the further latching lugs configured to support the containers.

26. A mixing device according to claim 16, wherein the at least one container connection comprises a vial connection.

27. A mixing device according to claim 11, wherein the vial connection comprises a protrusion projecting from an external surface of the connecting element.

28. A mixing device according to claim 24, wherein the protrusion is formed by a hollow needle.
